(19) United States
(12) Patent Application Publication
(10) Pub. No.: US 2014/0364176 A1
(43) Pub. Date: Dec. 11, 2014

(54) PHONE CASE WITH MOVABLE STRAP AND COVER

(71) Applicant: Daniel Pintor, Carson, CA (US)

(72) Inventor: Daniel Pintor, Carson, CA (US)

(21) Appl. No.: 14/296,257

(22) Filed: Jun. 4, 2014

Related U.S. Application Data
(60) Provisional application No. 61/832,095, filed on Jun. 6, 2013.

(51) Int. Cl. H04B 1/38; H04M 1/02

(52) U.S. Cl. CPC H04B 1/385; H04M 1/0202; H04B 2001/3861
USPC 455/575.6

(57) ABSTRACT

A cell phone case held by a user's finger(s) or propped up on a flat surface includes body that engages the cell phone, the body having a moveable strap allowing changes in cell phone orientation relative to the user's hand. The back panel also includes a cover which may be closed over the strap. When open, the cover can prop up the cell phone on the flat surface. The cover is capable of rotational movement for changing the orientation cell phone relative to the flat surface. This allows the user to prop up the cell phone in landscape or portrait orientation. In one embodiment; the body includes a cut-out to accommodate the cover with a ring for rotating it and a hinge between the ring and the cover for articulating the cover between a closed and open position.

This application claims the priority filing date of provisional application No. 61/832,095, filed Jun. 6, 2013.

### BACKGROUND

Cases for cell phones and other multimedia devices are known in the art. Typically these cases include a shell adapted to partially enclose the cell phone, including on the sides and back, while leaving the screen uncovered for viewing and interfacing with the cell phone. These cases also provide access portals for specific features, such as volume control, and cameras. and various electronic connections for power and audio among others.

Some cell phone cases include anchoring mechanisms such as clips or bands. For example, U.S. Pat. App. 2012/0267402 to Beatty discloses a grip and hands-free support for multimedia devices. While this support lacks an enclosure, it includes a grip base and elastic straps extending around the grip base. which allows users to insert a hand under the elastic straps to hold the multimedia device securely, to avoid dropping and damaging the multimedia device. This band is limited in that it only allows a user to hold the multimedia device in a single position, and is not adapted for use by a single finger, which is enough to securely hold most devices. Another drawback to bands like Beatty is that they are unsightly and since they do not present an attractive appearance are disfavored.

U.S. Pat. App. 2005/0205623 to Buntain discloses a hand-held electronic device retainer and positioned. A flexible material can be adhered to small devices such as cellular phones and performs as a retainer when a user inserts a finger or fingers between the flexible material and the device. This invention has several drawbacks, including that the flexible material has a tendency to come apart from the cell phone, resulting in a user dropping the phone. Also, this invention fails to provide a means of propping the phone in other than a horizontal position, which makes hands free operation impossible. Buntain also lacks the capacity for displaying custom indicia on the phone.

U.S. Pat. No. 7,469,809 to Rodarte discloses a carrier for a portable device having a hand strap coupled at opposite ends of a portable device. A bracket attachment allows the strap to be anchored to support a right-handed or left-handed orientation. Like Beatty, Rodarte is not adapted for use by a single finger, and is unsightly, in that it presents an unattractive appearance. Furthermore, Rodarte has no ability to provide customization or support indicia.

Cell phone cases with props for holding a cell phone at an angle for viewing on a surface are also known. These devices typically include a hinged leg or appendage adapted to be unfolded from the case. A major drawback to these devices is that they only allow the cell phone to be disposed in one orientation. Modern cell phones and other multimedia devices typically include functionality for viewing films or other programs in landscape orientation, and also for viewing websites and documents, which are typically in portrait orientation.

There is therefore a need for a cell phone case that includes the functionality of a prop adjustable for portrait, landscape and other orientations. A cell phone case is also needed which includes an anchoring mechanism allowing users to anchor the cell phone on one or more fingers in multiple orientations. Finally, there is a need for a cell phone case capable of displaying a desired emblem or indicia, such as a trademark, photo, or other image for customizing the case to a particular user.

### SUMMARY

A case for a conventional cell phone for holding by finger(s) of a user's hand and for propping up of the cell phone on a flat surface includes a body configured to engage the cell phone. The body preferably includes a back panel, which has a moveable strap sized to engage the user's finger(s) and allows changes in the orientation of the cell phone relative to the user's hand. The body also includes a cover which, in a closed position, is positioned over the strap. The cover in an open position is configured for propping up of the cell phone on the flat surface.

Preferably the cover is moveable capable of rotational movement, for changing the orientation cell phone relative to the flat surface. This allows the user to orient the cell phone in landscape or portrait orientation. In one embodiment, the case includes a cut out in the body to accommodate the cover. In one embodiment the case includes a ring in the cut out on the back panel. The ring is connected to the cover, such that the ring and cover can be rotated in the body to change the orientation of the cover relative to the cell phone. The strap may also be able to rotate relative to the cell phone, like the cover.

Although in the primary embodiment the back panel includes a circular cut out for accommodating the ring and cover, in some instances, the cover may be raised relative to the ring to provide an easier gripping surface. In other instances, both the cover and the ring may be raised relative to the back panel. Preferably, the cover is attached to the ring in a hinged manner, allowing the cover to swing out relative to the ring and back panel. The cover and the ring may both be a raised surface relative to the back panel.

Ideally, the cover will be attached to the ring with an articulating hinge allowing it to swing away from the back panel. In a preferred embodiment, the ring or cover will also include a catch opposite the hinge for locking the cover in a closed position against the back panel. The catch may be necessary in instances where the cover is biased to an open position. Additionally, the hinge may be separable to make the cover releasably connected to the back panel.

To use the cell phone case, a user first engages a cell phone within the case having a body with a rotatable articulating cover. The cover is first swung outward from the body of the case. Once the cover extends away from the body, it can be rotated relative to the cell phone to a desired position. This may include portrait and landscape orientations, among others. With the cover extending away from the body, the cell phone may be placed on a surface, supported by one side of the body and the cover. In addition to placing the cell phone on a surface, the cell phone case allows users to easily hold a cell phone with one finger by providing an elastic strap under the cover. By inserting the user's finger or fingers under the elastic strap, the cell phone may be held at a preferred angle by rotating the strap relative to the cell phone.

### BRIEF DESCRIPTION OF THE FIGURES

FIG. 1 is a perspective view of a cell phone case with an emblem cover.

FIG. 2 is a perspective view of the cell phone case with the emblem cover articulated away from the case, i.e., in an open configuration.

FIG. 3 is a perspective view of the cell phone case with the emblem cover open and showing a finger strap.

FIG. 4 is a perspective view of the cell phone case with the emblem cover open in a different orientation and showing a finger strap.

FIG. 5 is a perspective. view of the cell phone case with the emblem cover open and propping up the cell phone with the screen in landscape orientation.

FIG. 6 is a perspective view of the cell phone case with the emblem cover open. and propping up the cell phone with the screen in portrait orientation.

FIG. 7 is a perspective view of the cell phone case in use with a user's finger under the finger strap in portrait orientation.

FIG. 8 is a perspective view of the cell phone case in use with a user's finger under the finger strap in landscape orientation.

FIG. 9 is a perspective view of the cell phone case showing a customized, interchangeable logo.

### REFERENCE NUMBERS

10. Cell Phone Case.
11. Body
12. Cell Phone
13. Back Panel
14. Camera Portal
15. Cut Out Portion
16. Connector Portal
18. Emblem Cover
20. Indicia
22. Emblem Ring
24. Hinged Connection
26. Slot
28. Elastic Band
30. Catch

### DESCRIPTION

For purposes of description the term “cell phone” has been used with reference to the electronic apparatus protected by the cell phone case. It should be understood that “cell phone” is used by way of illustration and not limitation, and that any interactive personal electronic apparatus of similar size. e.g., a personal data assistant, mini tablet-type computer, etc., with or without telephony may be incorporated into the design.

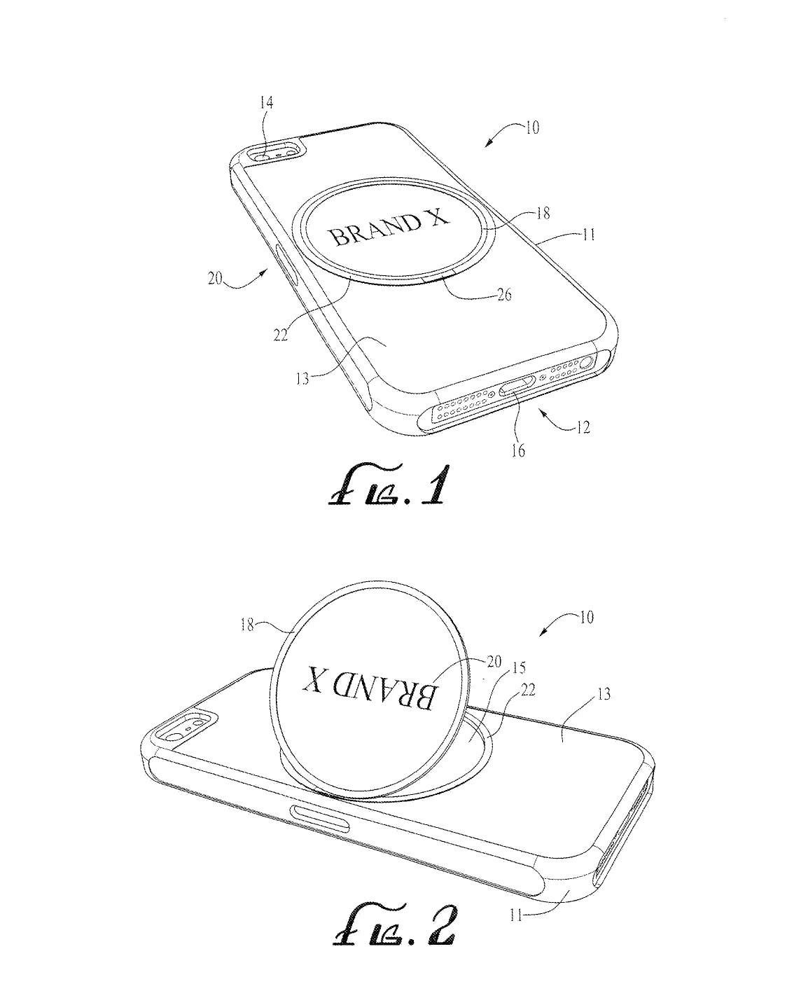

Referring to FIG. 1, the cell phone case 10 is formed to have a body 11, similar to conventional cell phone cases, and is designed to have a back panel 13 surround a cell phone 12 on all sides except for the screen. As with typical cell phone cases, the cell phone case 10 includes a camera portal 14 and a connector portal 16, to allow a user to use the features of the cell phone 12 without removing the cell phone ease 10. Also included on the cell phone case 10 is an emblem cover 18 emblazoned with indicia 20, such as a logo, trademark, or other customizable image. The emblem cover 18 in one embodiment is a circular cover, and is incorporated into an emblem ring 22, which is itself incorporated into the cell phone case 10, in a cut out portion 15 of the back panel 13.

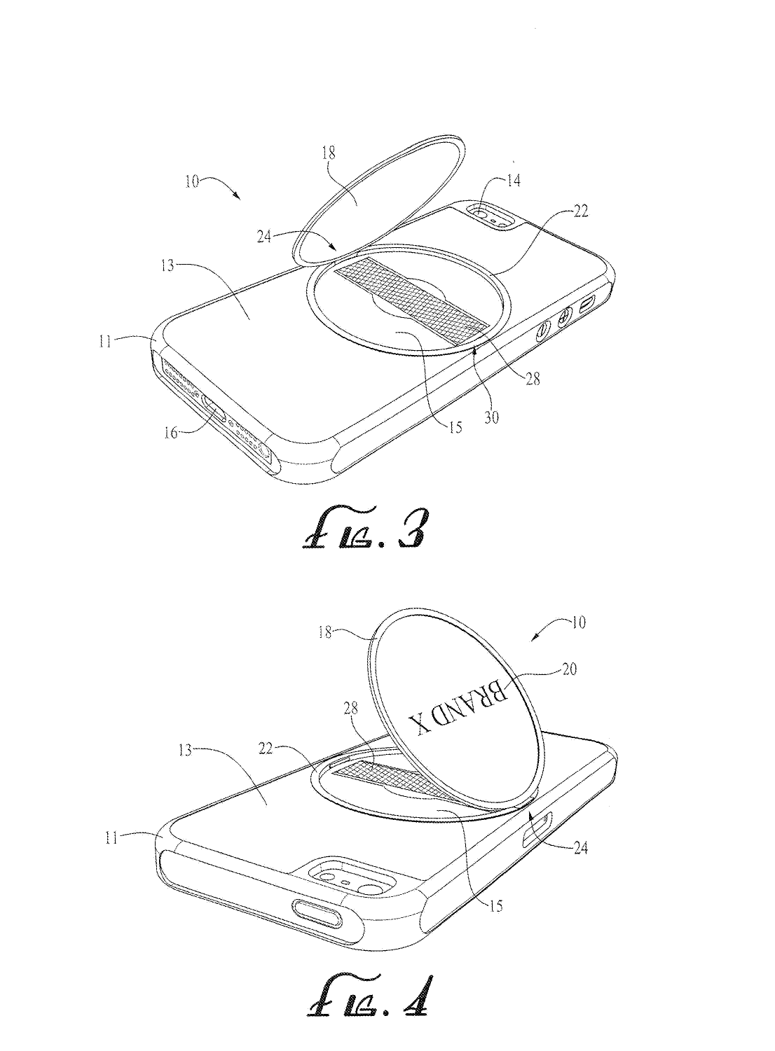

Referring to FIG. 2, the cell phone case 10 is shown with the emblem cover 18 raised relative to the emblem ring 22. Preferably, the emblem cover 18 includes a hinged connection 24 to the emblem ring, allowing the emblem cover 18 to articulate away from the cell phone case 10. In addition to the hinged connection 24, and to allow a user to easily articulate the emblem cover 18 relative to the emblem ring 22, a slot 26 (not shown) may be incorporated into the emblem ring 22, which allows the emblem cover 18 to catch on a user's finger (not shown) for lifting. The slot 26 and the emblem cover 18 may be made from non-slip rubber or similar material. The emblem ring 22 or the perimeter of the emblem cover 18 may also present a slightly raised portion of the case 10 for shock absorption and to prevent the cell phone 12 from sliding when placed on a flat surface. In another embodiment, the ring 22 may be incorporated into a housing to hold the ring in position.

Referring to FIG. 3, in addition to the emblem cover 18 being able to articulate relative to the emblem ring 22, the emblem ring 22 is itself able to rotate relative to the cell phone case 10, including 360° two-dimensional rotation. The emblem cover 18 may be rotated so that it opens in a variety of directions. The interface between the emblem ring 22 and the cell phone case 10 may also be adapted to include stops (not shown) at predetermined positions, to allow a user to open the emblem cover 18 in a position square to the cell phone case 10.

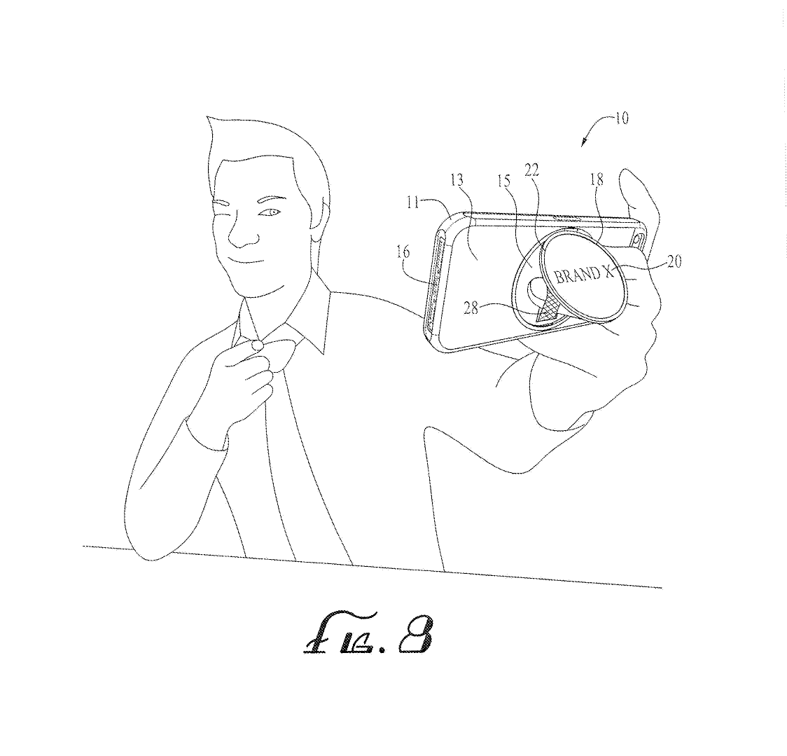

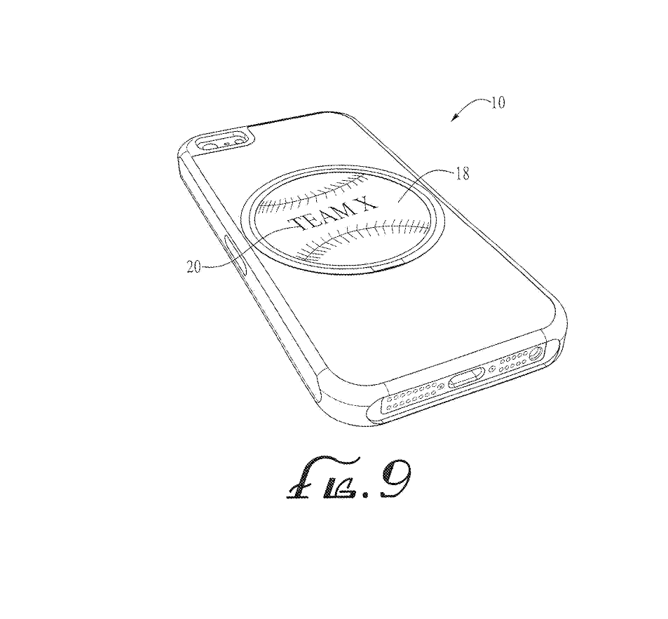

Still referring to FIG. 3, in a preferred embodiment, an elastic band 28 is disposed across the emblem ring 22, from the hinged connection 24 to the slot 26. The elastic band 28 is designed to allow a user to insert one or more fingers under the elastic band 28 (see FIGS. 7 and 8), thereby holding the cell phone case 10, and enabling a user to articulate the cell phone case 10 with one or more fingers. Also shown in FIG. 3 a catch 30 is designed to lock the emblem cover 18 in place when closed. In one embodiment the hinged connection 24 may be biased to predispose the emblem cover 18 in a closed position. In another embodiment the catch 30 may include a release for allowing the emblem cover 18 to articulate outward. Preferably, the catch 30 may allow the emblem cover 18 to pop up, allowing a user to easily move the emblem cover 18 to an open position. In yet another embodiment, the elastic band 28 may be adapted to remain in a static position as the emblem ring 22 is rotated.

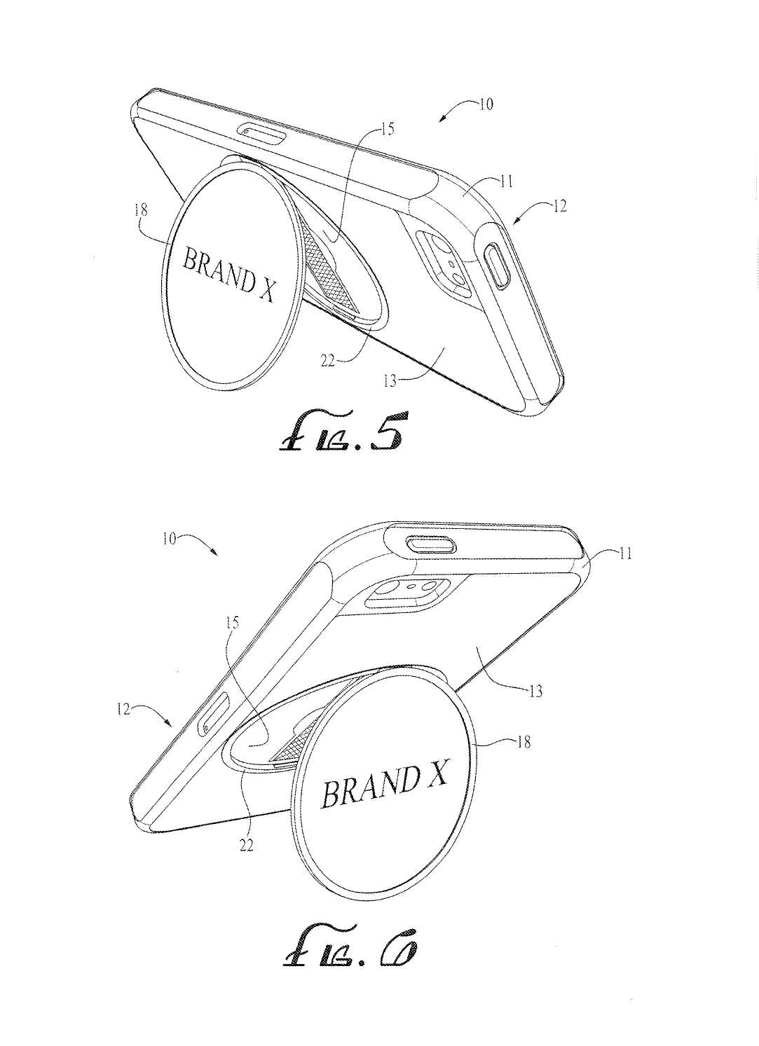

Referring to FIG. 4, a similar view shows the emblem cover 18 open in a different orientation. As shown in this view, the emblem cover 18 is oriented to show the indicia 20 in an upright arrangement relative to the cell phone 12 when held in a conventional manner. As discussed, stops (not shown) may predispose the emblem ring 22 in this position, while also allowing a user to rotate the emblem ring 22 as desired. It is possible to construct the emblem ring 22 with a removable emblem cover 18 via a disconnecting hinge 24. In this manner, different emblem covers may be swapped out as desired.

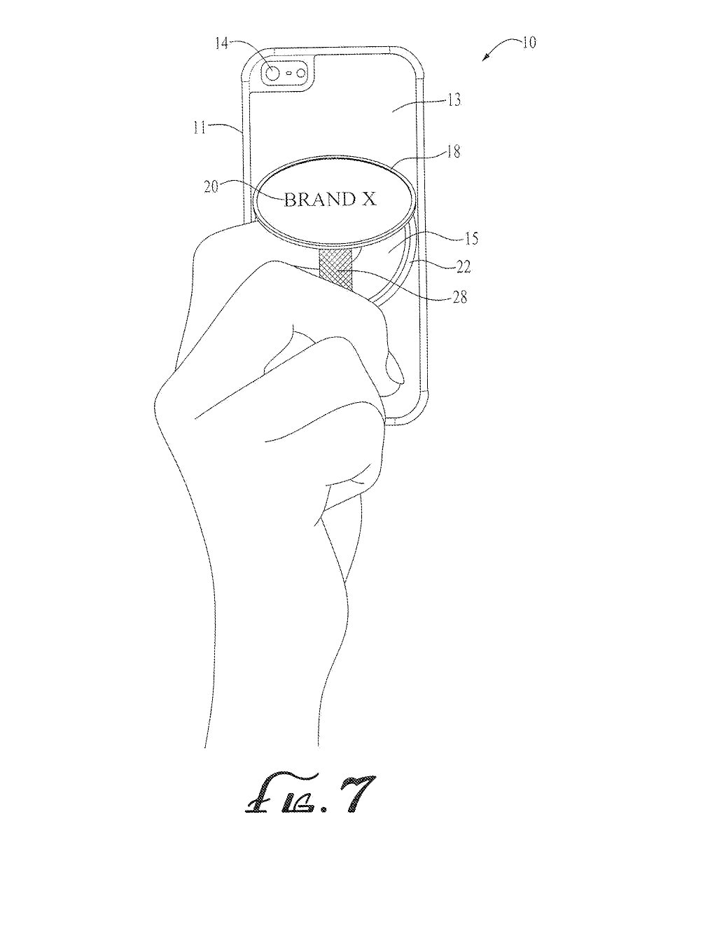

Referring to FIG. 5 the cell phone case 10 is shown with the emblem cover 18 articulated outward to form a support for propping up the cell phone 12. in this arrangement, the emblem ring 22 has been rotated such that the hinged connection 24 is at the top of the cell phone 12 when oriented in landscape view. Landscape view is suitable for maximizing the screen (not shown) of the cell phone 12. With the emblem cover 18 extending in this orientation, the cell phone may be placed on a surface for viewing movies or other content typically displayed at a 16:9 or similar ratio.

Referring to FIG. 6, the cell phone case 10 is shown with the emblem cover 18 articulated outward to form a support for propping up the cell phone 12. In this arrangement, the emblem ring 22 has been rotated such that the hinged connection 24 is closest to the top of the cell phone 12 when oriented in portrait view, as it would be when held by a user. Positioning the cell phone 12 in portrait orientation may be advisable when using the web browsing capabilities of the cell phone 12, since unlike movies websites are designed for portrait orientation viewing. Also, a locking hinge 24 may be used to keep the emblem cover 18 biased to an open position.

Still referring to FIG. 6, preferably, the hinged connection 24 (not shown) is designed so that when the emblem cover 18 is articulated outward, it rests at an angle at or beyond vertical when the cell phone 12 is placed on a level surface (not shown). In this manner, inadvertent closing of the emblem cover 18 will be avoided. In an alternative embodiment, the hinged connection 24 may have a lock (not shown) or be biased to an open position, thereby propping up the cell phone 12 even if the angle of the emblem cover 18 when open is less than vertical.

Referring to FIG. 7, when the emblem cover 18 is in an open position, in addition to being able to place the cell phone case 10 on a surface and have the cell phone 12 propped up, the elastic band 28 may be used to anchor the cell phone 12 on a user's finger. To use the elastic band 28, a user articulates the emblem cover 18 to an open position, and slips one or more digits (e.g., in the illustrated embodiment, an index finger) under the elastic band 28. Because of its elastic nature, the elastic band 28 will retain the user's finger, thereby anchoring the cell phone 12 to the user's hand.

Referring to FIG. 8, since the elastic band 28 travels with the emblem ring 22 along with the emblem cover 18, it may be rotated to another preferred orientation. Optionally, the elastic band 28 may rotate independently of the emblem cover 18, allowing a user to position the elastic band 28 in a variety of orientations. In this view, the band is shown oriented to the landscape view as shown in FIG. 5. Frequently, cell phones with incorporated cameras include functionality for taking portrait or landscape orientation photos. When the cell phone 12 is in a landscape position as shown, it will take a landscape orientation photo.

Still referring to FIG. 8, taking self photos, or video chatting functions are also typical of modern cell phones 12. Since reaching the portion of the screen responsible for activating and deactivating the camera (not shown) and for best viewing during these uses may be difficult, requiring articulating the user's fingers in an awkward or uncomfortable manner, users risk dropping the cell phone 12. By positioning the elastic band 28 in a manner that allows it to hold one or more of a user's fingers, a user may comfortably extend the cell phone 12 up to an arm's length away without risking dropping the cell phone 12.

Referring to FIG. 9, it is anticipated that the emblem cover 18 may bear indicia such as for a user's favorite sports team or other franchise. In this manner, the cell phone case 10 may be easily adapted for branding and for use as a promotional item. In another embodiment, the emblem cover 18 may include removable emblems, including a pop-out disk-type emblem cover 18, which users may replace as desired. In this embodiment, users have the ability to collect multiple emblem covers 18, effectively making the cell phone case 10 a fashion accessory.

The foregoing description of the preferred embodiment of the invention is sufficient in detail to enable one skilled in the art to make and use the invention. It is understood, however, that the detail of the preferred embodiment presented is not intended to limit the scope of the invention, in as much as equivalents thereof and other modifications which come within the scope of the invention as defined by the claims will become apparent to those spilled in the art upon reading this specification. For example, the hinged connection 24 may he formed of a variety of hinge types depending on the desired characteristics. Also, the emblem panel 18 may be rotatable to one of several biased positions and may have a locking mechanism to prevent it from articulating open.

What is claimed is:

1. A case for a conventional cell phone for holding by finger(s) of a user's hand and for propping up of the cell phone on a flat surface comprising:
a body configured to engage the cell phone;
the body having a movable strap sized for engaging the finger(s) and orienting the cell phone relative the user's hand;
the body further having a cover in a closed position over the strap;
the cover in an open position being configured for propping up of the cell phone on the flat surface;
the cover being moveable for orienting the cell phone relative the flat surface.

2. The case of claim 1 wherein the body has a back panel for nesting against the cell phone.

3. The case of claim 1 wherein the body has a cut out portion for housing the movable strap.

4. The case of claim 3 further comprising a ring in the cut out portion for rotating the cover relative the cell phone.

5. The case of claim 4 wherein the cover is hingedly attached to the body.

6. The case of claim 1 further comprising a catch to secure the cover to the body.

7. The case of claim 1 wherein the cover is biased to the open position.

8. The case of claim 1 wherein the cover is releasably connected to the body.

9. The cast of claim 2 wherein the cover in the closed position is substantially flush with the back panel.

10. A case for a conventional cell phone for holding by finger(s) of a user's hand and for propping up of the cell phone on a flat surface comprising:
a body for receiving the cell phone, the body having a back panel with a cut out;
an elastic strap located in the cut out for receiving the finger(s);
a cover encircled by a ring, the cover connected to the ring by a hinge;
the ring disposed in the cut out with the cover over the strap;
wherein the strap and the cover rotate relative the back panel, and the cover when swung to an open position away from the back panel, allows the user to prop up the case with the cover.

11. The case of claim 9 wherein the cover is biased to the open position.

12. The case of claim 9 wherein the cover is detachable from the ring.

13. The case of claim 9 wherein the cover presents a raised surface relative the back panel

14. A case for holding a conventional cell phone by a users fingers, and for propping up the cell phone on a surface comprising:
a means for rotatably holding the user's fingers against the case, thereby allowing the cell phone to be securely held and oriented between landscape and portrait positions;
a means for propping up the cell phone hingedly connected to the case; and
wherein the means for propping up the cell phone overlays the means for rotatably holding the user's fingers against the case and acts as a cover.

15. The case of claim 14 wherein the means for propping up the cell phone is rotatable relative the case, for orienting the cell phone between portrait and landscape positions.
